(19) United States
(12) Patent Application Publication
(10) Pub. No.: US 2014/0309951 A1
(43) Pub. Date: Oct. 16, 2014

(54) MULTI-CAPILLARY IN-LINE RHEOMETER FOR MINERAL SLURRIES

(71) Applicant: JRI INGENIERIA S.A., Nunoa (CL)

(72) Inventors: Alejandra ALVAREZ VALLEJOS, SANTIAGO (CL); Ramon FUENTES AGUILAR, SANTIAGO (CL); Soledad GUTIERREZ DELGADO, SANTIAGO (CL); Juan RAYO PRIETO, SANTIAGO (CL); Mario SOLIS SOTO, SANTIAGO (CL)

(73) Assignee: JRI INGENIERIA S.A., Nunoa (CL)

(21) Appl. No.: 14/063,808

(22) Filed: Oct. 25, 2013

(30) Foreign Application Priority Data
Oct. 26, 2012 (CL) 3019-2012

(51) Int. Cl. G01N 11/08

(52) U.S. Cl. CPC G01N 11/08
USPC 702/47; 73/54.06

(57) ABSTRACT

A rheometer for measuring non-Newtonian fluids is disclosed. The rheometer includes capillaries with piezometers therein, a pump, flow control valves, flow, density, and speed meters, and a controller. The rheometer has application in providing for online measurements of parameters including viscosity and yield stress in mining suspensions based upon laminar transportation of the suspensions by the capillaries.

### FIELD OF THE INVENTION

The present invention relates to the field of flow measurement, specifically a rheometer to measure specific parameters, preferably in the mining industry in conjunction with a method based on an algorithm developed on the basis of a multi-capillary measurement of physical variables which accurately provide key rheological measurements for the control of the pulp process in the mining industry.

### DESCRIPTION OF THE PRIOR ART

Chilean Copper mining is characterized by low grades, therefore, it is necessary to move and process large amounts of material from these mines. The transportation of interesting material, and waste is crushed and ground reaching, at the end of the process, sizes ranging from micrometers to millimeters. This material is mixed with water to form a suspension with varying concentrations of solids (weight concentrations typically range from 30% to 70%). Thus, due to the high concentrations of solids, the viscosity can be higher than water.

An important phenomenon that appears in this type of suspension is the yield stress: in simple terms, this can be described as the necessary initial force (per unit area) required by a suspension at rest to start moving, This effort must overcome forces related to the granular nature of the fluid at rest—even when in motion—which causes the fluid to be motion-resistant [BONN & DENN, 2009].

Viscosity (μ) and yield stress (τₒ) are two important parameters for the design of chutes and pipes for the transportation of these suspensions and also an important parameter when it comes to the operation of a plant. (See FIG. 1) In particular, the fluids that meet this line are called Bingham. This model, due to its linearity, is the most popular in industrial applications, however, there are other models such as the Ostwald & de Waele (see FIG. 1b, curve A and D), Herschel & Bulkley (see FIG. 1b, curve C), that eventually can be used [H. YAMAGUCHI, 2008].

The most popular techniques for measuring viscosity and other rheological properties are grouped into three categories [Y. Y. HOU & H. O. KASSIM, 2005]:
rotational techniques where viscosity is calculated by measuring the torque and the speed of the rotor;
techniques to measure the time a ball immersed in a fluid takes to fall a known distance
capillary techniques where the rheological properties are calculated from flows and pressure drops of the fluid within the capillary.

Although these techniques are well established, these instruments still have some limitations: such as manual operation, sedimentation, wall problems [R. BUSCALL, 2010] and in homogeneities of the fluid caused by temperature and fluid movement (thixotropy and viscoelasticity [J. MEWS & N J WAGNER, 2009]), phenomena particularly observed in complex suspensions such as mining [ST 2].

Today, mining companies characterize their suspensions discontinuously (batch), procuring services from laboratories, which at best can take a shift to deliver the viscosity values (μ) and the yield stress (τo). However, for the correct operation of these suspensions, an effective continuous and online measurement is required which considers the phenomenology associated to complex suspensions.

Literature reports several inventions of multi-capillary viscometers [DI 1 DI 3, DI 4 DI 6, DI 8 DI 9], however, they lack the online component required by the operation of industrial suspensions. Inventions DI 1, DI 2, instruments ST 1 and ST 3, and the work of OTHER AUTHORS [S. K. KAWATRA & A. K. BAKSHI, 1998; A. K. BAKSHI, 1999; S. H. CHIU et al., 1999; Q. D. NGUYEN et al., 2000; A. K. AKSHI et al., 1997] were created for online measurements, and reported methods [DI 3, DI 4, DI 5 DI 6, DI 7, ST 4] do not solve the problems associated to complex suspensions. All these inventions do not include the effects associated to complex mining suspensions (such as tailings or concentrates) and, therefore, are not useful in controlling the operation of an industrial plant online.

### SUMMARY OF THE INVENTION

The proposed invention corresponds to a rheometer which measures viscosity (μ) and yield stress (τₒ) simultaneously online, with measurements at intervals of a few minutes (probably 5-10 minutes) for mining suspensions. Therefore, the design must withstand common conditions of a mining operation (extreme temperature, geographic altitude, communications problem, distance, humidity, low humidity, theft, misuse, etc.). This rheometer is based on laminar transportation of the suspension by capillaries. The online measurement and analysis system considers the effects of sedimentation, wall problems, temporary effects (thixotropy) and entrance effects.

### BRIEF DESCRIPTION OF THE DRAWINGS

FIG. 1a shows a graph for a Bingham non-Newtonian fluid showing yield stress and viscosity.

FIG. 1b shows a graph with other rheological models for non-Newtonian fluids: Ostwald & de Waele: curves A and D, Herschel & Bulkley: curve C.

FIG. 2 shows a diagram of the rheometer of the invention and its parts

FIG. 3 shows a diagram of the distribution piece to the capillaries

FIG. 4 shows a diagram of one of the capillaries, the piezometers, and the measurements made in said capillary.

FIG. 5 shows an apparent rheogram of a pulp at 70 wt % solid flowing through the capillary (either of them). The effects of pressure drop, entrance and wall are shown.

FIG. 6 shows a rheogram obtained from apparent rheogram and optimization. Direct results are shown uncorrected and corrected.

FIG. 7 shows a chart of the temporary evolution of the viscosity measured sequentially on three capillaries.

FIG. 8 shows a chart of the temporary evolution of the yield stress measured sequentially on three capillaries.

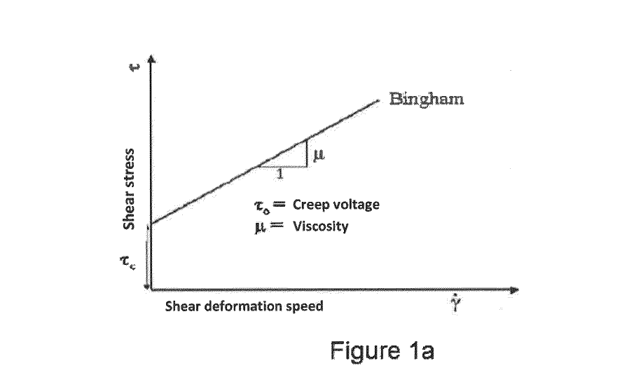

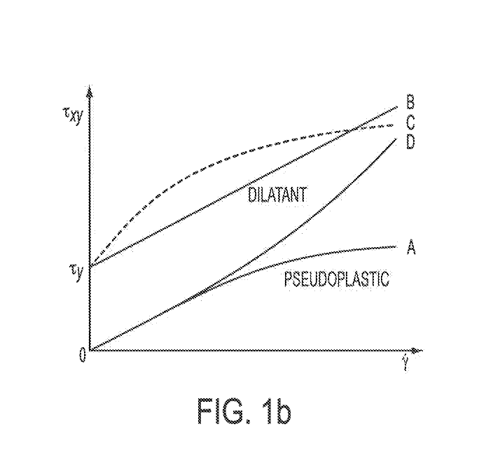

### DETAILED DESCRIPTION OF THE INVENTION

A preferred embodiment of this invention consists of a box (1) containing a suspension, a very small part of this suspension is diverted to the rheometer by means of a positive displacement pump (2). Connected to the pump outlet (2) is a distribution piece (5) which powers three vertical capillaries (6) of different diameters, the power is given alternately to each of the capillaries, that is, the three capillaries (6) are not measured simultaneously. In each of the three capillaries (6) six piezometers (7) are installed in pairs and at three different heights in the capillary in order to have redundancy. Three capillaries (6) of different diameter are used, to have a greater number of points on the rheological curve. Between the positive displacement pump (2) and the distribution piece (5), a density meter (4) and a flow meter (3) are installed to measure density and flow of the fluid sample to be measured before reaching the piezometers (7). The capillaries outlet can be connected directly to the box (1) or other receptacle. Once the measurement at each capillary is finished, these are purged with a cleaning system (15) and exhaust valves (14) to prevent particulate matter accumulation on the walls of capillaries.

In each of the capillaries, the suspension speed (v (r)) is measured, (13) using for such purpose instruments such as sonar, ultrasound (mapping of UPD ultrasonic pulses and USV spectroscopy), nuclear magnetic resonance (NMR), and NMR images (NMRi).

With the pressure drop data measured with the piezometers (8) plus density and flow, viscosity (μ) and yield stress (τₒ) can be determined from an analysis algorithm specially designed for the extraction of information and analysis described below.

The invention includes a microcontroller (9) which controls the components of the rheometer, collects data, and executes their processing, calculating the values of rheological variables and performing due corrections to the phenomena associated to complex suspensions (entrance effects, wall effects, and temporary effects), the microcontroller (9) is in the electrical house of the equipment and usually very close to it. The data obtained by this microcontroller (9) are sent by cable or wirelessly to the house where a server (10) is found, which processes the data for the management and administration of the operation variables. Angular deformation speed (end point), stress, viscosity, and yield stress are calculated on the microcontroller, which has a software that controls the duration of the measurement, cleaning of the capillary (6) of a certain radius R, and the opening and closing of valves (12) (14) and (15) of the capillaries (6). The information obtained will be stored in a historical database (11) of the operation installed on a server (10). Historical data can be analyzed through a platform for such purpose, and deployment of online information can be incorporated into flowcharts (flowsheet) of the operation as another parameter. The database in the server stores historical data for statistical and trend analysis in different periods (hours, shifts, days, months, etc.), and these data are displayed in trend curves with warning criteria in cases of unexpected variations.

The server (10) may be accessed from the control room of the operation, and by any authorized network user. Measurement will be performed alternately in each capillary (6). Measurement of flow and density will be continuous. Before starting the operation, representative samples are taken for laboratory analysis on rheology, granulometry or any other relevant parameter.

As mentioned above, the proposed rheometer, and the information obtained by it, works in conjunction with an analysis algorithm to finally obtain the viscosity values (μ) and the yield stress (τo).

The analysis algorithm includes all necessary corrections to remove parasitic effects. In general, these effects will be calibrated depending on the quality of the suspension.

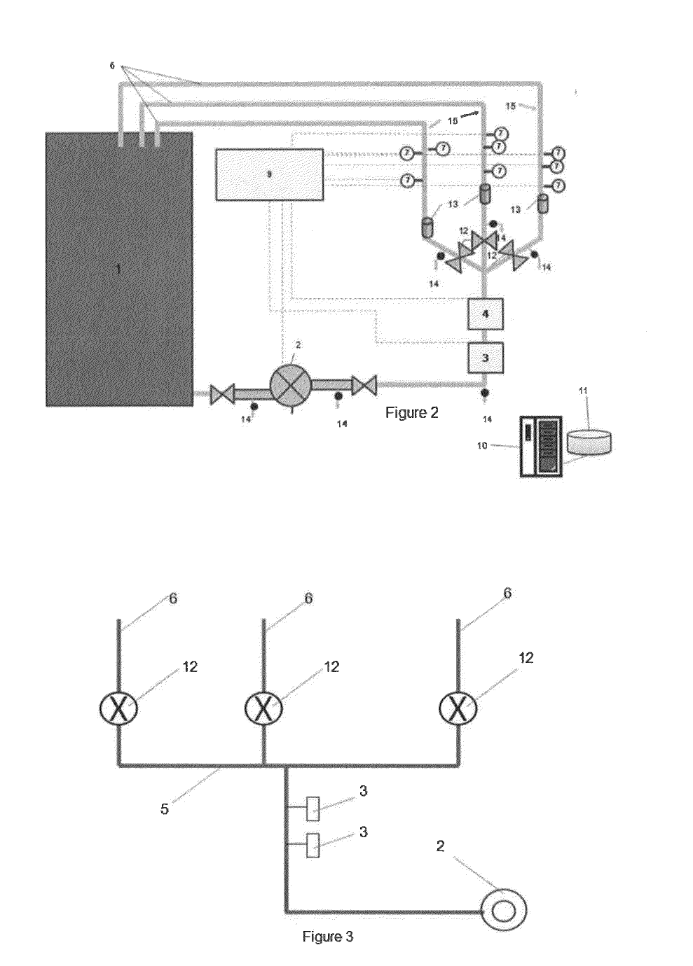

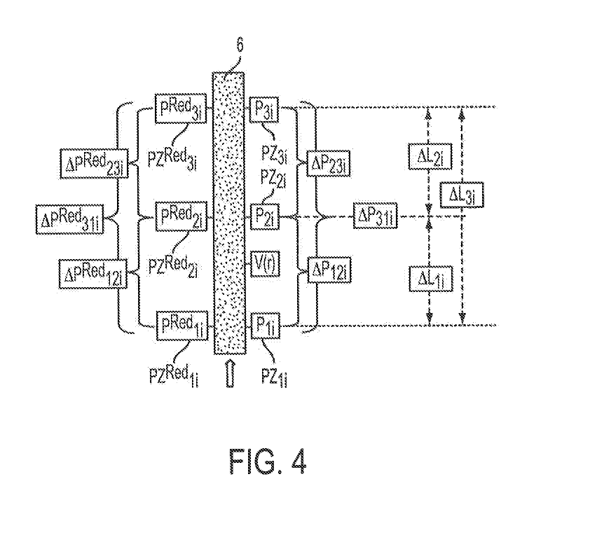

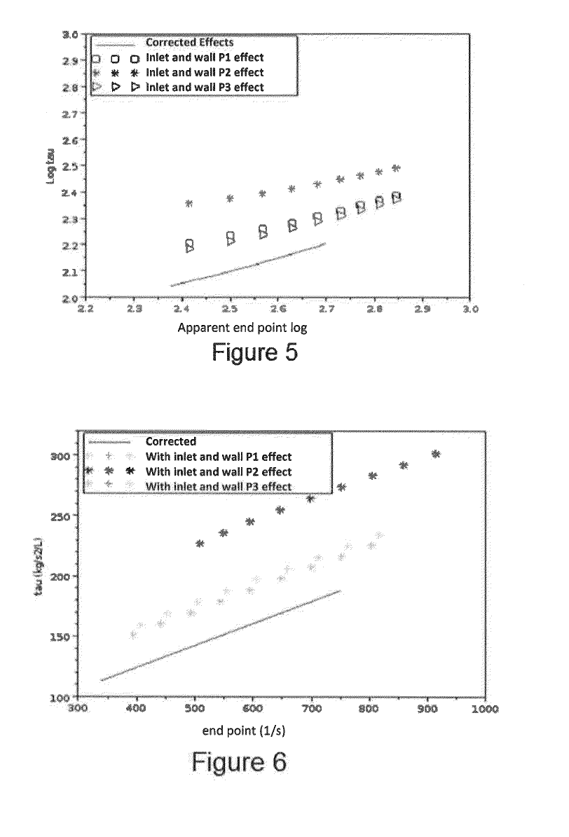

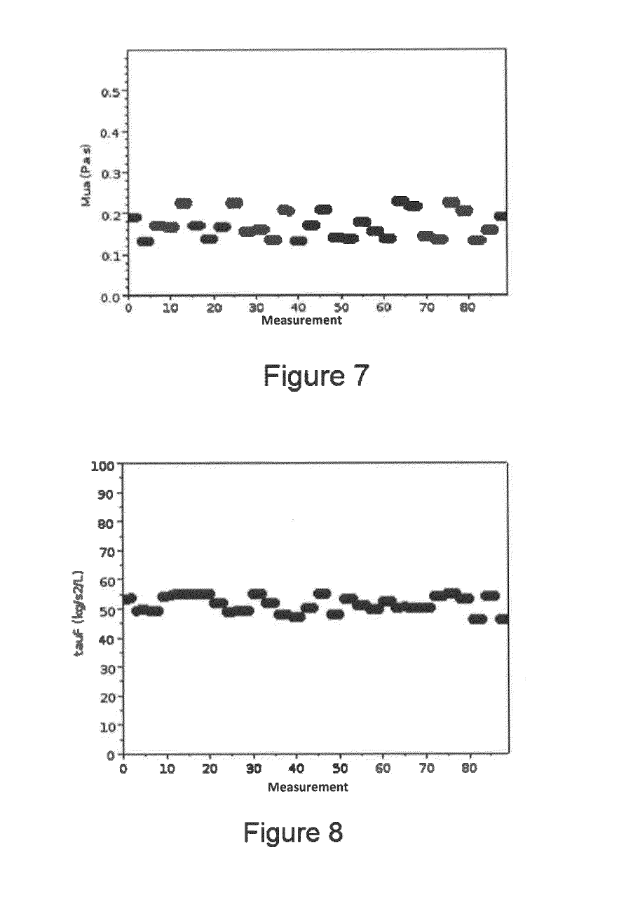

The method for the use of the algorithm described, using the rheometer and explained based on FIG. 3 showing one of the capillaries, involves:
At three different heights of each of the capillaries (6) groups are arranged with two piezometers (PZₖ₁, PZ^{red}ₖ₁), (PZₖ₂, PZ^{Red}ₖ₂), (PZₖ₃, PZ^{Red}ₖ₃), the second piezometer of each group (superscript Red) is used should the other fail. The index k indicates the kth capillary.
b) In each group of two piezometers (PZₖ₁, PZ^{Red}ₖ₁), (PZₖ₂, PZ^{Red}ₖ₂), (PZₖ₃, PZ^{Red}ₖ₃), a pressure measurement will be obtained (P₁ₖ, p^{Red}₁ₖ), (p₂ₖ, P^{Red}₂ₖ), (p₃ₖ, P^{Red}₃ₖ) using only one of each pair. The subscript k indicates the capillary and Red indicates redundancy.
c) In each capillary there will be six measurements on pressure differences (ΔP₁₂ₖ, ΔP₂₃ₖ, ΔP₃₁ₖ) and (ΔP^{Red}₁₂ₖ, ΔP^{Red}₂₃ₖ, ΔP^{Red}₃₁ₖ). The superscript Red indicates a measurement of redundancy and the subscript k indicates the capillary.
d) Distances between each group of two piezometers are known (PZₖ₁, PZ^{Red}ₖ₁), (PZₖ₂, PZ^{Red}_{K2}), (PZₖ₃, PZ^{Red}ₖ₃), which are called ΔL₁, ΔL₂ and ΔL₃, in general, for the three capillaries, these distances will be ΔL₁ₖ, ΔL₂ₖ and ΔL₃ₖ, where k indicates the capillary, 1 indicates the distance between PZₖ₁ and PZₖ₂, 2 indicates the distance between PZₖ₂ and PZₖ₃, and 3 indicates the distance between PZₖ₃ and PZₖ₁ of capillary k.
e) With pressure values measured in the three groups of two piezometers (PZₖ₁, PZ^{Red}ₖ₁), (PZₖ₂, PZ^{Red}ₖ₂), (PZₖ₃, PZ^{Red}ₖ₃) and the distances between them ΔL₁ₖ, ΔL₂ₖ and ΔL₃ₖ, pressure gradients are calculated for each pair of piezometers of the capillaries:

$${P}_{12 k}^{′} = \frac{Δ {P}_{12 k}}{Δ {L}_{1 k}} , {P}_{23 k}^{′} = \frac{Δ {P}_{23 k}}{Δ {L}_{2 k}}$$

$${P}_{31 k}^{′} = \frac{Δ {P}_{31 k}}{Δ {L}_{3 k}}$$

Where P′ᵢⱼₖ corresponds to the pressure gradient of capillary k between piezometers j and i.
f) With element V(r), speed profile v(r) is measured, this measurement is used to correct the flow rate due to wall effects.
g) Pressure corrections are made for entrance effects and wall sliding

$$1 ) lim ( {Δ P ( Q , L / R )}_{L / R -> 0} ) = Δ {P}_{entrance} , Δ {P}_{real} = Δ {P}_{p} - Δ {P}_{e} \\ 2 ) {Q}_{real} = Q - {Q}_{p}$$

where ΔPₑ is the pressure drop for entrance effects, ΔPₚ measured by piezometers, and Qₚ is the flow modification for wall effects.
h) Now shear stresses are calculated using the corresponding diameter and pressure gradients

$${τ}_{w} = \frac{Δ P}{Δ L} \frac{R}{2}$$

i) Average speed is calculated, with the flow rates and diameter

$$V = \frac{4 Q}{R}$$

j) Apparent angular deformation speed is calculated

$${\dot{γ}}_{a} = \frac{4 V}{R}$$

k) The first point of apparent rheogram is obtained.
l) This procedure is repeated N times for this capillary.
m) Valve of capillary 2 is opened, and then valve of capillary 1 is closed and capillaries 1 and 3 are purged.
n) Steps a) to l) are carried out for capillary 2.
o) Valve of capillary 3 is opened, then valve of capillary 2 is closed and capillary 2 is purged.
p) Steps a) to l) are carried out for capillary 3.
q) With this new amount of data, entrance and wall effects are rechecked and a new apparent rheogram is calculated.
r) Data are displayed in trend curves, with warning criteria in cases of unexpected variations.
s) A statistical analysis is performed of the control period (hours, shift, week, months, years).

### REFERENCES

D. BONN & M. M. DENN, 2009, Science 324, 12 Jun. 2009

H. YAMAGUCHI, 2008, “Fluid Mechanics and its Applications”, Volume 85, Springer Science+Business Media B.V.

Y. Y. HOU & H. O. KASSIM, 2005, Rev. Sci, Instrum. 76, 101101.

R. BUSCALL, 2010, J. Rheol. 54 (6), 1177-1183 November/December

J. MEWIS & N. J. WAGNER, 2009, Advances in Colloid and Interface Science 147-448.

S. K. KAWATRA & A. K. BAKSHI, 1998; Min. & Metall Proc. 15 (4), November

Z. Y. Wang et al., 2010, AlChE Journal, 56 (6), June.

A. K. BAKSHI, 1998, http://www.onemine.org/search/summary.cfm/OnLine-Rheometer-For-Mineral- Slurries?d=853ECD182568FC1FC3B1F4A56C04FDF6E3557D1F3E41273938EAC7DED7DF3DAA1 77925&fullText=eisele&start=50

S. H. CHIU et al. 1999, Polymer degradation and stability, 64 (2), pages 239-242

Q. D. NGUYEN et al., 2000, Min. Pro. Err. Met. Rev. 20. pp. 75-91

A. K. AKSHI et al., 1997, http://www.onemine.org/search/summary.cfm/Plant-Trial-of-a-New-Online-Pressure- Vessel-Rheometer-For- Slurries?d=5DB1789EF354B111886146ACD74CEAA5171C508812560327C8909F3C5BD0E4992008

DI 1: US2002088953; DUAL RISER/DUAL CAPILLARY VISCOMETER FOR NEWTONIAN AND NON-NEWTONIAN FLUIDS, Kennet Kensey et al,

DI 2: US6182503; ON-LINE RHEOLOGICAL MEASUREMENT FOR PROCESS CONTROL; Mode Pul g. et al.

DI 3: RU2434221; METHOD OF DETERMINING RHEOLOGICAL CHARACTERISTICS OF NON-NEWTONIAN LIQUIDS; Pokras IL'ja Borosovich.

DI 4: US2007068229; CAPILLARY BRIDGE VISCOMETER AND METHOD FOR MEASURING SPECIFIC VISCOSITY; Steven Trainoff

DI5: US2012/0192625; EXPERT-SYSTEM-BASED RHEOLOGY ; John Paul Wilkinson

DI 6: US 5637790; THREE CAPILLARY FLOW-THROUGH VISCOMETER ; José L. de Corral

DI 7: US5652376; US5652376 METHOD OF MEASURING YIELD STRESS; deleeuw david charles et al

DI 8: CN201955286; CN201955286 MULTI-TUBE TYPE CAPILLARY RHEOMETER; suojun zhang et al

DI9: CN2114159; MULTI-CAPILLARY VISCOMETER

ST1 http://www.dynisco.com/online-rheometer-viscosensor

ST2 http://www.mch.cl/revistas/imprimir articulo.php?id=868

ST3: http://www.asi-team.com/asi%20tream/gottfert/Gottfert%20data/SSR.pdf

ST4: http://www.malvern.de/labGer/products/bohlin/rh7/rh7.htm

What is claimed:

1. A rheometer for measuring non-Newtonian fluids such as mining suspensions which allows for online measurements and obtaining quick results comprising:
a) at least two capillaries (6)
b) a pump (2)
c) a distribution piece (5)
d) flow control valves (12)
e) a flow meter (3) and a density meter (4)
f) speed meter (13)
g) at least a pair of piezometers (7) in each of the capillaries
h) valves for exhaustion (14)
i) valves for the entrance of cleaning water (15)
j) a microcontroller (9)
k) data transmission means
l) a server and a database (10,11)

2. The rheometer according to claim 1, wherein the capillaries (6) have different diameters and can have equal or different lengths

3. The rheometer according to claim 1, wherein at each capillary (6) the suspension speed (v(r)) (13) is measured

4. The rheometer according to claim 3, wherein for measuring the suspension speed (v(r)) instruments can be used, such as sonar, ultrasound (mapping of UPD ultrasonic pulses and USV spectroscopy), nuclear magnetic resonance (NMR) and NMR images (NMRi)

5. The rheometer of claim 1, wherein the pump (2) is a positive displacement pump.

6. The rheometer of claim 1, wherein the pump (2) directs the flow to the capillaries (6).

7. The rheometer of claim 1, wherein the pump (2) is controlled by the microprocessor (9).

8. The rheometer of claim 1, wherein the distribution piece (5) is located off of the pump (2),

9. The rheometer of claim 1, wherein the distribution piece (5) comprises at least two arms.

10. The rheometer of claim 1, wherein the distribution piece (5) divides the flow of the pump (2) to the capillaries (6).

11. The rheometer of claim 1, wherein the flow control valves (12) control the flow to each of the capillaries (6),

12. The rheometer of claim 1, wherein the flow control valves (12) are controlled by the microprocessor (9) and operate alternately.

13. The rheometer of claim 1, wherein each pair of piezometers (7) is located in pairs at different heights of each capillary (6).

14. The rheometer of claim 1, wherein each capillary has a cleaning system (14) and (15).

15. The rheometer of claim 1, wherein the measurements obtained by the flow meters (3) and density (4), speed (13) and the measurements obtained in the piezometers (7) are used to perform rheometric calculations using an algorithm.

16. The rheometer of claim 1, wherein the micro controller (9) synchronizes the rheometer components

17. The rheometer of claim 1, wherein the micro controller (9) collects data and performs processing of such data.

18. The rheometer of claim 16, wherein the microprocessor (9) transmits the data and its processing to the server (10) by transmission means which can be cable or wirelessly.

19. The rheometer of claim 1, wherein the server (10) and the database (11) post-analyze, store and process data sent through the transmission means from the microprocessor.

20. The rheometer of claim 1, wherein the database in the server stores historical data for statistical and trend analysis in different periods (hours, shifts, days, months, etc.)

21. The rheometer of claim 20, wherein the data are displayed in trend curves, with warning criteria in cases of unexpected variations.

22. A method for the use of a rheometer using an algorithm comprising:
a) At three different heights of each of the capillaries (6) groups are arranged with two piezometers (PZₖ₁, PZ^{Red}ₖ₁), (PZₖ₂, PZ^{Red}ₖ₂), (PZₖ₃, PZ^{Red}ₖ₃), the second piezometer of each group is used as a redundancy should the other fail. The index k indicates the kth capillary.
b) In each group of two piezometers (PZₖ₁, PZ^{Red}ₖ₁), (PZₖ₂, PZ^{Red}ₖ₂), (PZₖ₃, PZ^{Red}ₖ₃), the same pressure measurement will be obtained (P₁ₖ, PZ^{Red}₁ₖ), (P₂ₖ, P^{Red}₂ₖ), (P₃ₖ, P^{Red}₃ₖ) using only one of each pair. The subscript k indicates the capillary and Red indicates redundancy.
c) In each capillary there will be three measurements on pressure differences (ΔP₁₂ₖ, ΔP₂₃ₖ, ΔP₃₁ₖ) and (ΔP^{Red}₁₂ₖ, ΔP^{Red}₂₃ₖ, ΔP^{Red}₃₁ₖ).
d) Distances between each group of two piezometers are known (PZₖ₁, PZ^{Red}ₖ₁), (PZₖ₂, PZ^{Red}ₖ₂), (PZₖ₃, PZ^{Red}ₖ₃), which will be called ΔL₁, ΔL₂ and ΔL₃, in general, for the kth capillary, these distances will be ΔL_{1K}, ΔL₂ₖ and ΔL₃ₖ, where k indicates the capillary, 1, 2, or 3 . . . n.
e) With pressure values measured in the three groups of two piezometers (PZₖ₁, PZ^{Red}ₖ₁), (PZₖ₂, PZ^{Red}ₖ₂), (PZₖ₃, PZ^{Red}ₖ₃) and the distances between them ΔL₁ₖ, ΔL₂ₖ and ΔL₃ₖ, pressure gradients are calculated:
$${P}_{12 k}^{′} = \frac{Δ {P}_{12 k}}{Δ {L}_{1 k}} , {P}_{23 k}^{′} = \frac{Δ {P}_{23 k}}{Δ {L}_{2 k}}$$
$${P}_{31 k}^{′} = \frac{Δ {P}_{31 k}}{Δ {L}_{3 k}}$$
Where P′ᵢⱼₖ corresponds to the pressure gradient of capillary k between piezometers j and i.
f) With element V(r), speed profile v(r) is measured, this measurement is used to correct the flow rate due to wall effects.
g) Pressure corrections are made for entrance effects and wall sliding
$$3 ) lim ( {Δ P ( Q , L / R )}_{L / R -> 0} ) = Δ {P}_{entrance} , Δ {P}_{real} = Δ {P}_{p} - Δ {P}_{e} \\ 4 ) {Q}_{real} = Q - {Q}_{p}$$
Where ΔPₑthe pressure drop for entrance effects, ΔPₚ measured by piezometers, and Qₚ is the flow modification for wall effects, Qₚ is the flow rate due to wall effects, Q is the flow rate measured by the flowmeter and R is the capillary radius
h) Now shear stresses are calculated (τ_{w}) using the corresponding capillary radius and pressure gradients.
$${τ}_{w} = {P}_{ijk}^{′} \frac{R}{2}$$
Where P′ᵢⱼₖ corresponds to the pressure gradient between the j and l of capillary k and R is the radius of the capillary (Diameter D=2R).
i) Average speed (V) is calculated, with the flow rates and capillary radius.
$$V = \frac{4 Q}{R}$$
j) Apparent angular deformation speeds are calculated (\dot{γ}_{α}).
$${\dot{γ}}_{a} = \frac{4 V}{R}$$
k) The first point of apparent rheogram is obtained.
l) This procedure is repeated N times for this capillary.
m) Valve of capillary 2 is opened, and then valve of capillary 1 is closed and capillaries 1 and 3 are cleaned
n) Steps a) to l) are carried out for capillary 2.
o) Valve of capillary 3 is opened, then valve of capillary 2 is closed and capillary 2 is cleaned
p) Steps a) to l) are carried out for capillary 3.
q) Valve of capillary n is opened and then valve of capillary n-1 is closed.
r) Steps a) to l) are carried for capillary n.
s) With this new amount of data, entrance and wall effects are rechecked and a new apparent rheogram is calculated.
t) Measured points are checked and values are smoothed and/or outliers are removed.
u) Rheological model is chosen which best fits the laboratory measurements (e.g. Bingham) or microprocessor is required to try a different model.
v) Resulting points are subjected to some method for obtaining angular deformation speed (e.g. the Rabinowitsch-Mooney method [Z. Y. Wang et al., 2010]).
w) Rheological parameters of the model are obtained by optimization (for example, the least squares method).
x) A curve is obtained from which the yield stress and viscosity are obtained.
